(19) United States
(12) Patent Application Publication
(10) Pub. No.: US 2010/0068325 A1
(43) Pub. Date: Mar. 18, 2010

(54) PELLET ARTICLE FORMING APPARATUS

(76) Inventor: Chin-Wen CHOU, Taipei Hsien (TW)

Correspondence Address: Muncy, Geissler, Olds & Lowe, PLLC, P.O. BOX 1364, FAIRFAX, VA, 22038-1364, US

(21) Appl. No.: 12/210,379

(22) Filed: Sep. 15, 2008

(51) Int. Cl. B29C 43/36

(52) U.S. Cl. 425/410

(57) ABSTRACT

A pellet article forming apparatus includes a bottom mold and a top mold. The bottom mold has at least one forming cavity to hold polymer powder. The forming cavity has a first arched surface at the bottom that has an edge extended to form a first compression surface and an opening to hold a thrust member. The top mold is located above the bottom mold and has a second arched surface opposing the first arched surface. The second arched surface has another edge formed a second compression surface corresponding to the first compression surface. The top mold and the bottom mold are movable against each other to provide a compression force to the polymer powder held in the forming cavity to form a desired pellet article. The pellet article thus formed has a desired genuine spherical surface. Damage of the molds that might otherwise occur due to compression can be prevented.

### FIELD OF THE INVENTION

The present invention relates to a forming apparatus and particularly to a pellet article forming apparatus.

### BACKGROUND OF THE INVENTION

Forming pellet articles through conventional powder die casting often cannot produce a genuine spherical shape and results in undesirable quality or requiring a longer grinding process to achieve desired quality.

Take a plastic bullet (also called BB bullet) used in an air gun as an example. The bullet with a non-genuine spherical shape or bristles on the surface is prone to clog the barrel of the air gun. Such a phenomenon could cause wearing or deformation of the barrel and result in inaccurate shooting. The conventional method of producing BB bullets usually adopts inverted molds as shown in FIGS. 1A through 1D. A powder material 20 for making the BB bullets is disposed in a forming mold which mainly includes an upper mold 11, a lower mold 12 and a middle mold 13. The upper mold 11 and lower mold 12 have respectively an upper arched surface 111 and a lower arched surface 121 on an opposing side corresponding to each other. The middle mold 13 has a plurality of forming troughs 131 to guide the upper and lower molds 11 and 12 to form compression between them. During operation, first, the lower mold 12 and the middle mold 13 are coupled together, and the lower mold 12 held in the forming trough 131 as shown in FIG. 1A; next, dispense a desired amount of the powder material 20 in to the forming trough 131 onto the lower mold 12 as shown in FIG. 1B; then dispose the upper mold 11 in the forming trough 131 at another side and move against the lower mold 12 to compress the power material 20 held between them so that the powder material 20 is formed in a desired shape through the arched surfaces 111 and 121 as shown in FIG. 1C. The upper and lower molds 11 and 12 have respectively an arched edge 112 and 122 at opposing pointed ends, during compression the arched edges 112 and 122 are in contact with each other. In order to form a pellet 21 the power material 20 must be compressed at a great pressure between the upper and lower molds 11 and 12, the arched edges 112 and 122 tend to deform. Hence during production of the BB bullets, the upper and lower molds 11 and 12 are often spaced from each other at a selected distance. The arched edges 112 and 122 of the upper and lower molds 11 and 12 cannot be a genuine semi-sphere, otherwise the pellet 21 being produced could become elliptical with a long axis and a short axis. After the compression is finished, the upper and lower molds 11 and 12 are moved upwards to expose the pellet 21 outside the forming trough 131. Finally the pellet 21 is removed from the lower arched surface 121 as shown in FIG. 1D.

Referring to FIG. 2A, to adjust the arched edges 112 and 122 of the upper mold 11 and lower mold 12 makes the whole appearance look like spherical when coupled together, but the pellet 21 being formed has a bulged corner angle 22 at the contact location of the arched edges 112 and 122. To be used in the air gun, the pellet 21 needs surface treatment by grinding to remove the corner angle 22 as shown in FIG. 2B. The ground pellet 21 has a smoother surface, but the genuine spherical shape suffers. This could result in bullet clogging or inaccurate shooting. Moreover, the grinding process of the surface treatment requires more process time and makes production cost higher. It is not economically justified.

### SUMMARY OF THE INVENTION

The primary object of the present invention is to enhance the life span of pellet article fabrication apparatus and to produce pellet articles with a desired genuine spherical shape and quality. To achieve the foregoing object the invention provides a pellet article forming apparatus which includes a bottom mold and a top mold. The bottom mold has at least one forming cavity to hold polymer powder. The forming cavity has a first arched surface at the bottom that has an edge extended to form a first compression surface and an opening to hold a thrust member. The top mold is located above the bottom mold and has a second arched surface at one end opposing the first arched surface and another edge formed a second compression surface corresponding to the first compression surface. The top mold and the bottom mold are movable against each other to provide a required compression force to the polymer powder held in the forming cavity to form a desired pellet article.

In one aspect the first and second arched surfaces are mating semi-spherical surfaces so that after the polymer powder is compressed the pellet being formed has a desired genuine spherical shape. The thrust member has one end located in the opening and has a third arched surface adjacent to the first arched surface to form a complete curve. The first and second compression surfaces are horizontal surface or form an angle with a horizontal surface.

In another aspect the first and second compression surfaces at the edges of the first and second arched surfaces aim to increase the contact area of the bottom mold and top mold to prevent damage of the molds during compression. The distance between the top mold and bottom molds can also be reduced or eliminated to allow the pellet being formed through the first and second arched surfaces has a desired genuine spherical shape to reduce grinding time in the downstream process.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1A through 1D are schematic views of production processes for fabricating conventional BB bullets.

FIG. 2A is a plane view of a pellet fabricated through a conventional method.

FIG. 2B is a plane view of a pellet fabricated through a conventional method after finish grinding.

FIG. 3 is a sectional view of an embodiment of the pellet article forming apparatus of the invention.

FIGS. 4A, 4B and 4C are schematic views of production processes for fabricating air gun bullets according to the invention.

FIG. 5A is an enlarged fragmentary view according to FIG. 4B.

FIG. 5B is a schematic view of the invention showing an angle formed between the first and second compression surfaces.

FIG. 5C is a schematic view of the invention showing an angle formed between the opening and the first arched surface.

FIG. 6A is a plane view of a pellet article formed by the invention.

FIG. 6B is a plane view of a pellet article formed by the invention after finish grinding.

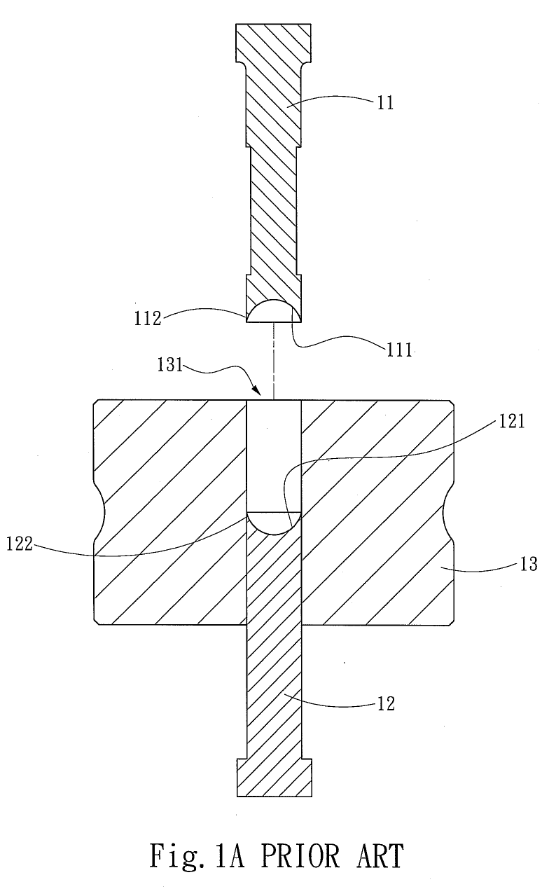

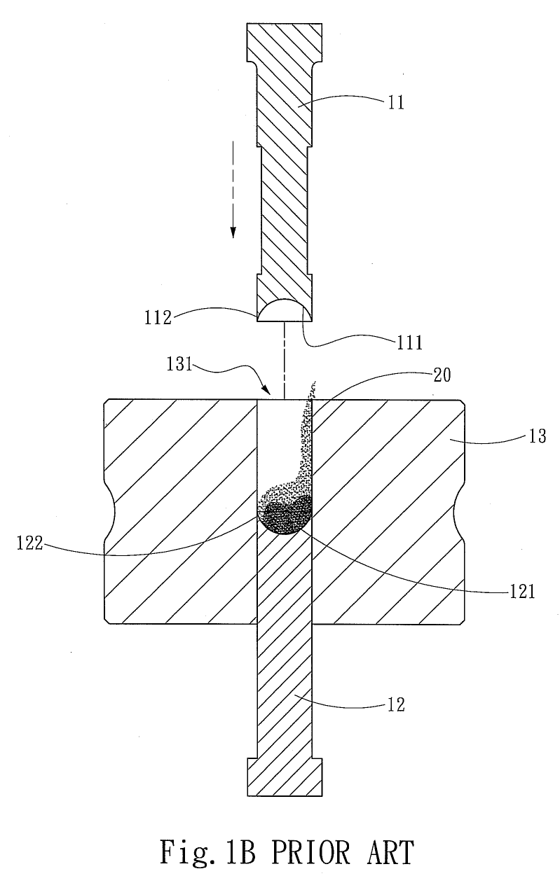

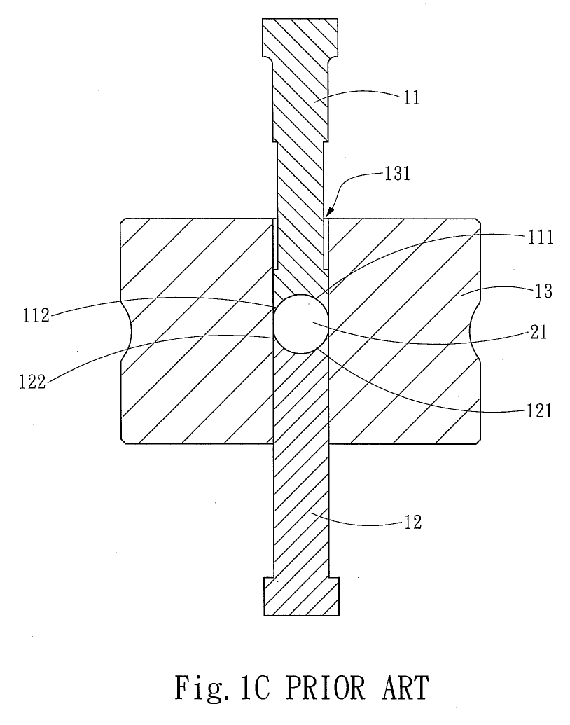

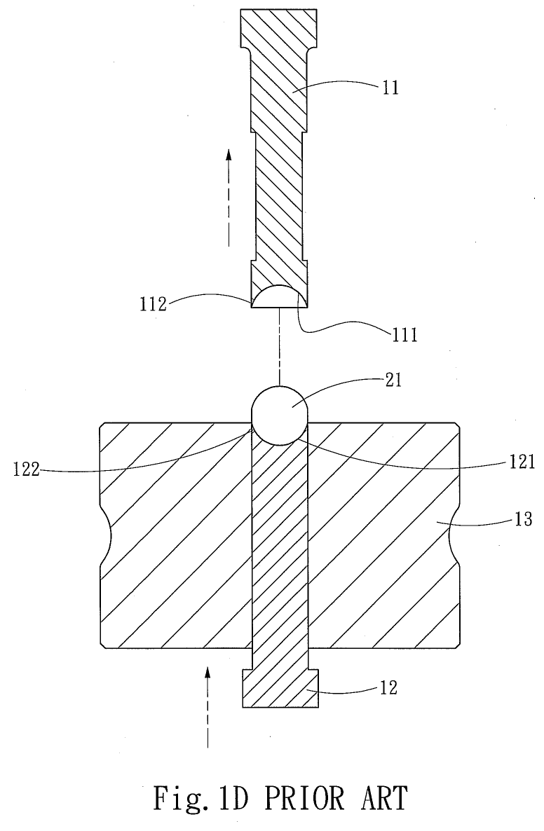

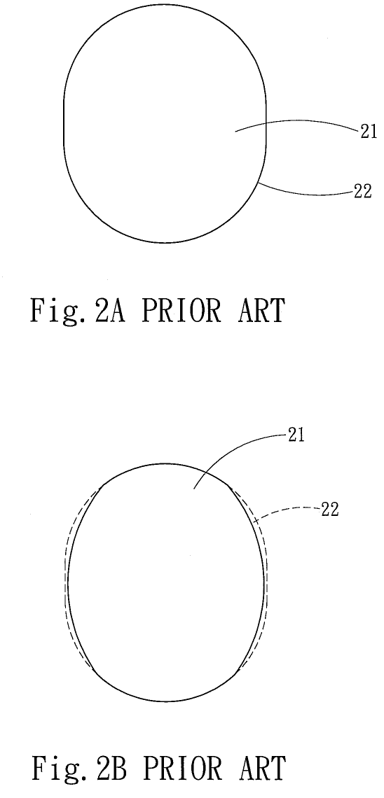

### DETAILED DESCRIPTION OF THE PREFERRED EMBODIMENTS

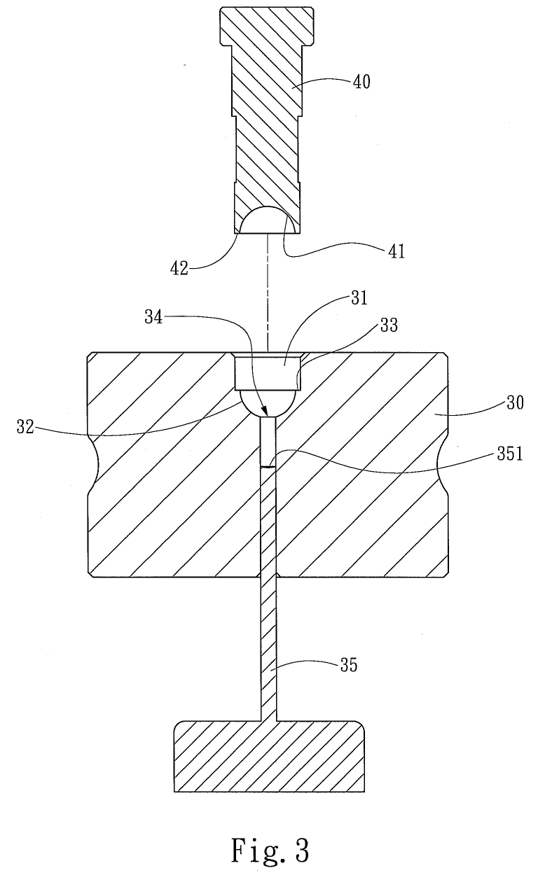

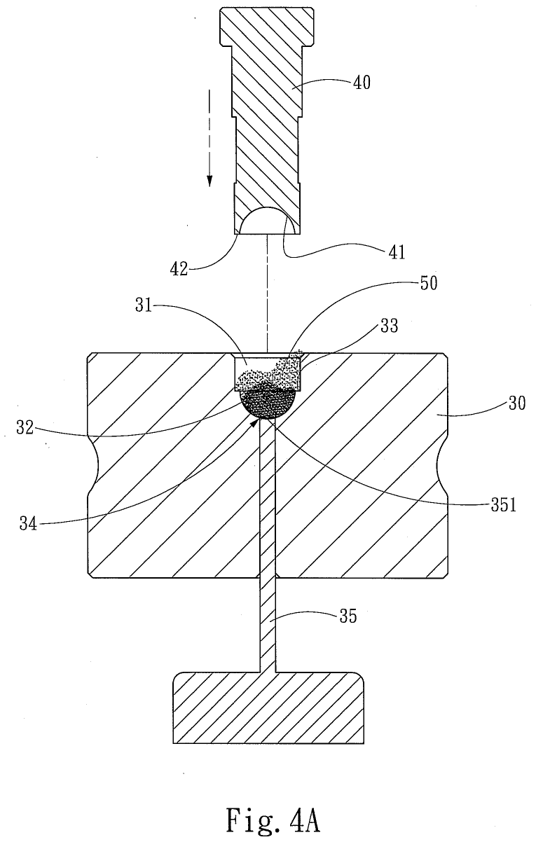

Please referring to FIG. 3, the pellet article forming apparatus according to the invention includes a bottom mold 30 and a top mold 40. The bottom mold 30 has at least one forming cavity 31 to hold polymer powder. The forming cavity 31 has a first arched surface 32 at the bottom that has an edge extended to form a first compression surface 33 and an opening 34 to hold a thrust member 35. The top mold 40 is located above the bottom mold 30 and has a second arched surface 41 at one end opposing the first arched surface 32. The second arched surface 41 has another edge formed a second compression surface 42 corresponding to the first compression surface 33. The top mold 40 and the bottom mold 30 are movable against each other to provide a required compression force to the polymer powder held in the forming cavity 31 to form a desired pellet article.

The first and second compression surfaces 33 and 42 at the edges of the first arched surface 32 and second arched surface 41 are corresponding to each other such that the bottom mold 30 and top mold 40 can be moved close to each other or in a contact manner to prevent forming a gap between them. The first arched surface 32 and second arched surface 41 are semi-spherical surfaces and corresponding to each other so that the pellet article compressed between the first arched surface 32 and the second arched surface 41 is formed with a desired genuine spherical shape. The thrust member 35 held in the bottom mold 30 aims to push the finished pellet outside the forming cavity 31 of the bottom mold 30, and has one end located in the opening 34 and formed a third arched surface 351 adjacent to the first arched surface 32 to form a complete curve. Thus the finished pellet has a desired surface without defects caused by pushing of the thrust member 35.

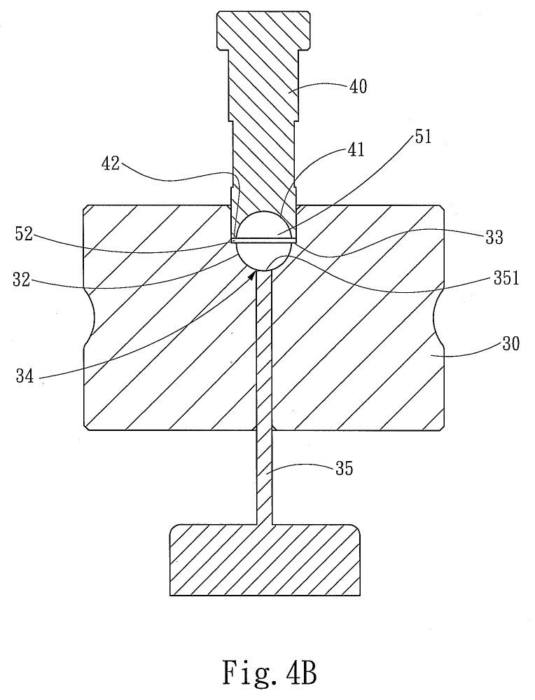

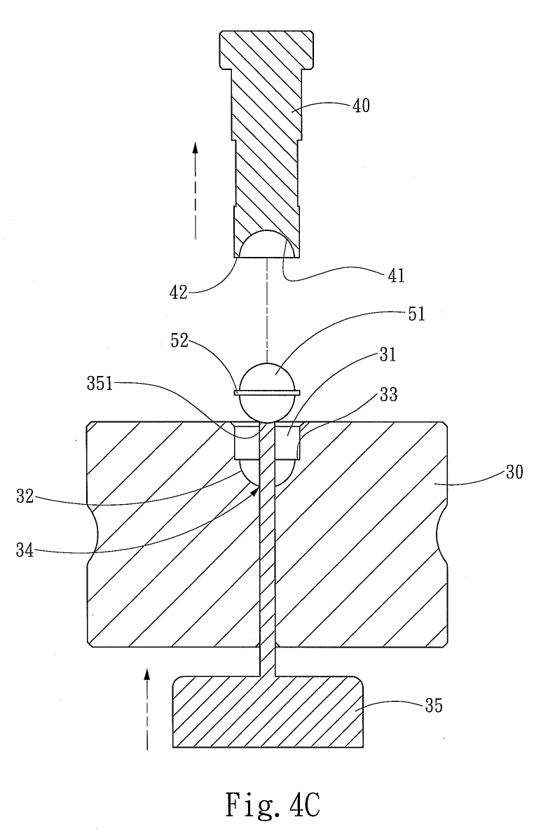

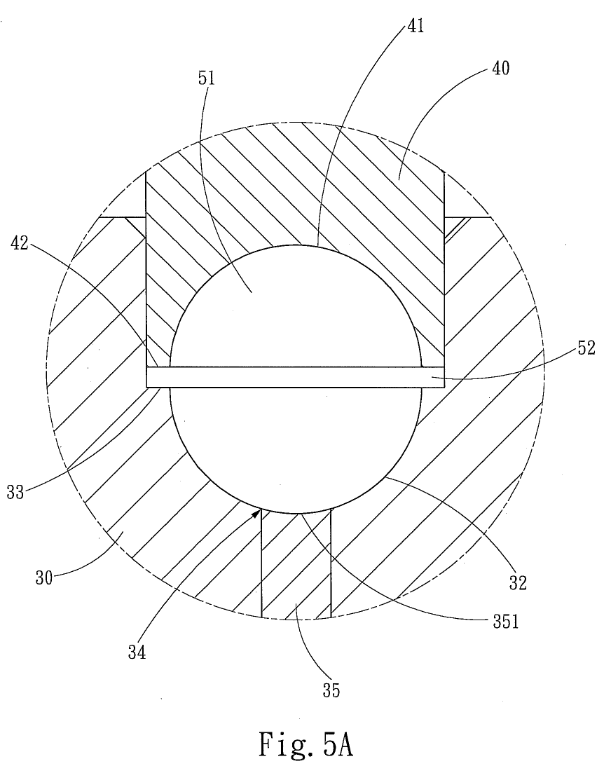

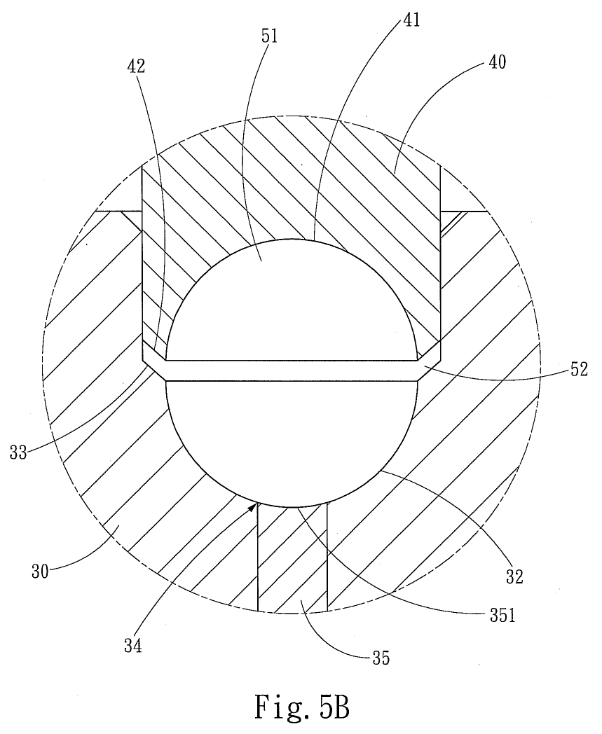

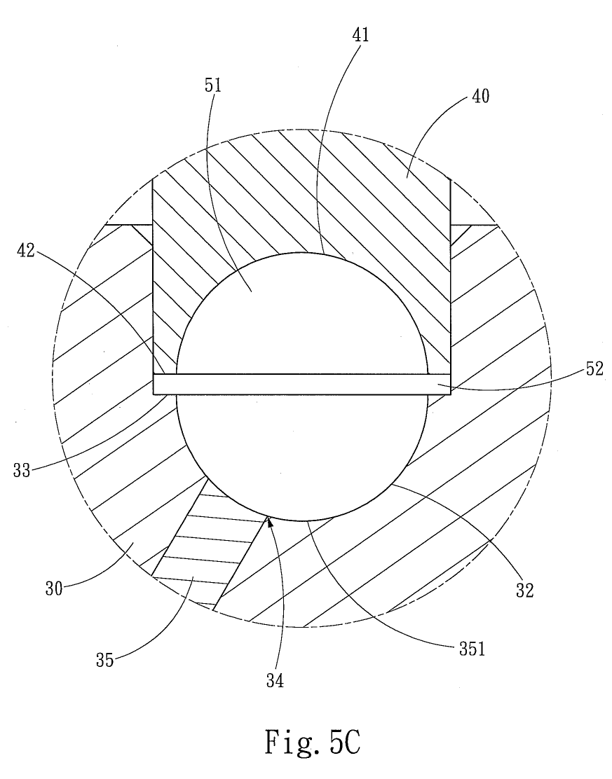

Refer to FIGS. 4A, 4B and 4C for the fabrication process of air gun bullets according to the invention. Before the polymer powder 50 is dispensed in the mold for compression, the thrust member 35 is held in the bottom mold 30 at a desired elevation so that the third arched surface 351 and the first arched surface 32 of the bottom mold 30 form a continuous curved surface (referring to FIG. 4A); next, dispense the polymer powder 50 in the forming cavity 31 of the bottom mold 30. In this embodiment the polymer powder 50 is lime powder or degradable bio powder to produce BB bullets. The invention may also be adapted for other polymer powder 50 to produce other different pellet articles 51, such as degradable compounds for making medical tablets or pellets. After the polymer powder 50 has been dispensed in the forming cavity 31, the top mold 40 is moved towards the forming cavity 31 and the first arched surface 32 of the forming cavity 31until the second compression surface 42 and the first compression surface 33 are moved close to or even in contact with each other as shown in FIG. 4B. Also referring to FIG. 5A, while the polymer powder 50 is dispensed, a small amount might be dropped to the first compression surface 33, or be squeezed between the first and second compression surfaces 33 and 42 due to the compression force applied to the top mold 40 during the compression process, and a thin annular flange 52 might be formed on the periphery between the first and second compression surfaces 33 and 42. In this embodiment, the first and second compression surfaces 33 and 42 are horizontal surfaces as shown in FIG. 5A. They also may form an angle with the horizontal surface as shown in FIG. 5B. While the top mold 40 is moved downwards, the polymer powder 50 held in the forming cavity 31 is compressed between the first and second arched surfaces 32 and 41 to become a pellet article 51. When the compression is finished, the top mold 40 and the thrust member 35 in the forming cavity 31 are moved upwards, and the thrust member 35 pushes the finished pellet article 51 outside the forming cavity 31 as shown in FIG. 4C. Then the pellet article 51 can be removed mechanically or manually. In the invention, the opening 34 disposed to hold thrust member 35 can be formed in the center of the first arched surface 32 as shown in FIG. 5A, or at a biased position to form an angle with the center of the first arched surface 32 as shown in FIG. 5C.

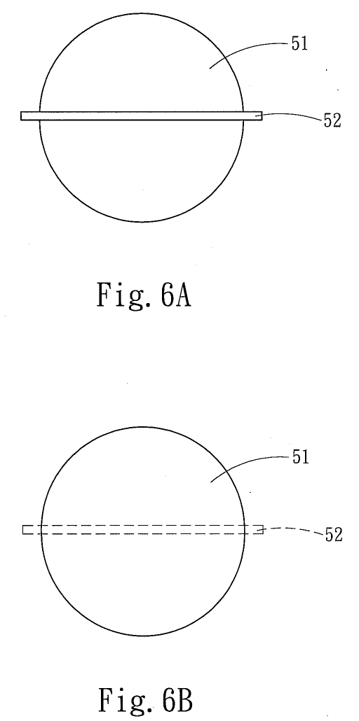

Refer to FIGS. 6A and 6B for a preferred embodiment of the invention, the surface of the pellet article formed after molding and grinding. As the first and second arched surfaces 32 and 41 are semi-sphere, the pellet article 51 formed by compression of the polymer powder 50 has a desired genuine spherical shape. And a thin annular flange 52 might be formed on the surface between the first and second compression surfaces 33 and 42 as previously discussed. The pellet article 51 thus formed requires surface treatment by grinding to remove the thin annular flange 52. This grinding process is shorter than the conventional process to form the desired genuine spherical shape. Thus production time and cost can be reduced.

As a conclusion, the invention provides the first compression surface and second compression surface extended from the edges of the first and second arched surfaces of the bottom mold and top mold so that the contact area of the bottom mold and top mold is larger. Therefore the structure damage caused by compression of the bottom mold and top mold to compress the polymer powder can be prevented. In addition, the top mold and bottom mold can be moved closer to or even in contact with each other during the compression process so that the pellet article formed through the first and second arched surfaces has a desired genuine spherical shape and the time needed for grinding in the downstream process decreased. Thus economic effectiveness increases. It provides a significant improvement over the conventional technique.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A pellet article forming apparatus, comprising:
a bottom mold having at least one forming cavity to hold polymer powder, the forming cavity having a first arched surface at the bottom that has an edge extended to form a first compression surface and an opening to hold a thrust member; and
a top mold which is located above the bottom mold and has a second arched surface at one end opposing the first arched surface, the second arched surface having another edge formed a second compression surface corresponding to the first compression surface;
wherein the top mold and the bottom mold are movable against each other to provide a compression force to compress the polymer powder held in the forming cavity to form a pellet article.

2. The pellet article forming apparatus of claim 1, wherein the first arched surface and the second arched surface are respectively a semi-spherical surface corresponding to each other.

3. The pellet article forming apparatus of claim 1, wherein the first compression surface and the second compression surface are horizontal surfaces.

4. The pellet article forming apparatus of claim 1, wherein the first compression surface and the second compression surface form an angle with a horizontal surface.

5. The pellet article forming apparatus of claim 1, wherein the thrust member has one end located in the opening and formed a third arched surface adjacent to the first arched surface to form a continuous curve.

6. The pellet article forming apparatus of claim 1, wherein the opening is formed in the center of the first arched surface.

7. The pellet article forming apparatus of claim 1, wherein the opening forms an angle with the center of the first arched surface.
